(19) United States
(12) Patent Application Publication
(10) Pub. No.: US 2011/0080733 A1
(43) Pub. Date: Apr. 7, 2011

(54) Speaker with leds and lampshell

(76) Inventor: Hui-Hsiung Wang, Zhonghe City (TW)

(21) Appl. No.: 12/588,028

(22) Filed: Oct. 1, 2009

(51) Int. Cl. F21V 33/00

(52) U.S. Cl. 362/253

(57) ABSTRACT

A speaker, comprises a shell, a lampshell, and an illuminating device. The upper side of the shell has a base. The lampshell is located below the base. The lampshell combines with the base. The lampshell has an illuminating portion. The illuminating device is located between the lampshell and the base. The illuminating device has a LED board and a plurality of LEDs, and the LEDs electrically connect on the bottom of the LED board. By such an arrangement, the present invention provides sound and emits beam/light as well. The present invention is innovative and able to illuminate.

### BACKGROUND OF THE INVENTION

1. Field of the Invention

The present invention relates to a speaker, in particular, to a speaker with LEDs and lampshell/light transmitting cover.

2. Description of Related Art

Speakers are common sound-producing devices in our human daily life. In the past, humans generally focused on the sound effects but did not care that much about the outer structure of the speakers.

However, as time goes by, people are pursuing light and sound effects simultaneously. With the speakers providing only sound can not catch people's eyes. Therefore, some speaker manufactures started creating some speakers on which the shell or outer casing or enclosure has a plurality of grooves. Small light bulbs have been arranged in those grooves. The small light bulbs can emit light when the speakers provide sound.

Although the light bulbs mentioned above can emit beams, not only is the life of the light bulbs temporary, but also the point source of the bulbs makes the users feel uncomfortable.

### SUMMARY OF THE INVENTION

The main object of the present invention is to provide a speaker with LEDs and lampshell that provides sound and emits general light and/or beams as well.

To attain the object mentioned above, as seen in the accompanying exemplary drawings, the present invention provides a speaker with LEDs and lampshell, case, or outer enclosure, comprising: a shell, case, outer enclosure, or the like, the upper side of the shell has a base; a lampshell or lamp-holding arrangement, located below the base. The lampshell combines with the speaker, and the lampshell has an illuminating portion; and an illuminating device, located between the lampshell and the base, the illuminating device has an LED board and a plurality of LEDs; the LEDs electrically connect on the bottom of the LED board.

The present invention has many merits including, at least: the present invention of adopting LEDs, such that the present invention is able to illuminate, to save electrical power when in use, and to have a longer life. As compared to the prior art point-sourced light, the beams/diffuse light emission pass from the illuminating portion will be less harsh and equally arranged. Additionally, the present invention has the capacity to replace several lamps.

To further understand the techniques, means, and effects the present invention applies for achieving the prescribed objectives, the following detailed description and appended drawings are hereby referenced, such that and through which, the purposes, features, and aspects of the present invention may be thoroughly and concretely appreciated; however, the appended drawings are merely provided for reference, illustration, and convenience, without intending any limitation of the true scope of the present invention.

### BRIEF DESCRIPTION OF THE DRAWINGS

FIG. 1 is a cutaway view of the present invention;

FIG. 2 is a exploded view of the present invention;

FIG. 3 is a side (lateral) view of the present invention;

FIG. 4 is a bottom view of the present invention;

FIG. 5 is an upper view of the present invention;

FIG. 6 is a perspective view of the buckle device of the present invention;

FIG. 7 is a side (lateral) view of the buckle device of the present invention;

FIG. 8 is an another side (lateral) view of the buckle device of the present invention;

FIG. 9 is an upper view of the buckle device with the present invention;

FIG. 10 is an side (lateral) view of the buckle device with the present invention;

FIG. 11 is a cutaway view of FIG. 9;

FIG. 12A is an upper view of the buckle device with the present invention before contacting with the ceiling;

FIG. 12B is a schematic view of the buckle device with the present invention before contacting with the ceiling;

FIG. 13A is an upper view of the buckle device with the present invention contacting with the ceiling;

FIG. 13B is a schematic view of the buckle device with the present invention contacting with the ceiling;

FIG. 14A is an upper view of the buckle device with the present invention after contacting with the ceiling;

FIG. 14B is a schematic view of the buckle device with the present invention after contacting with the ceiling;

FIG. 15 is a perspective view of another buckle device of the present invention;

FIG. 16 is a front view of another buckle device of the present invention;

### DETAILED DESCRIPTION OF THE PREFERRED EMBODIMENTS

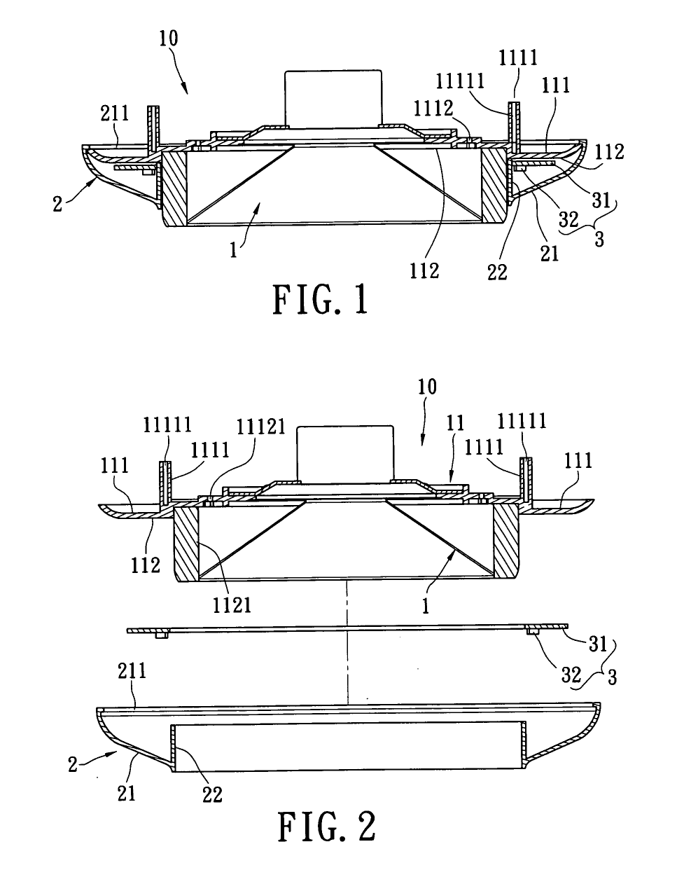

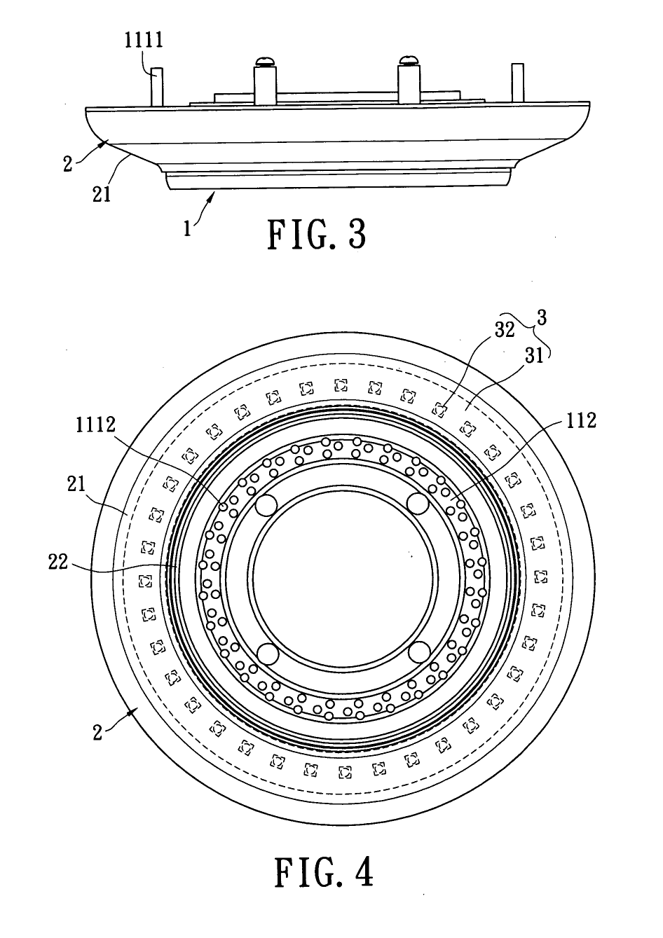

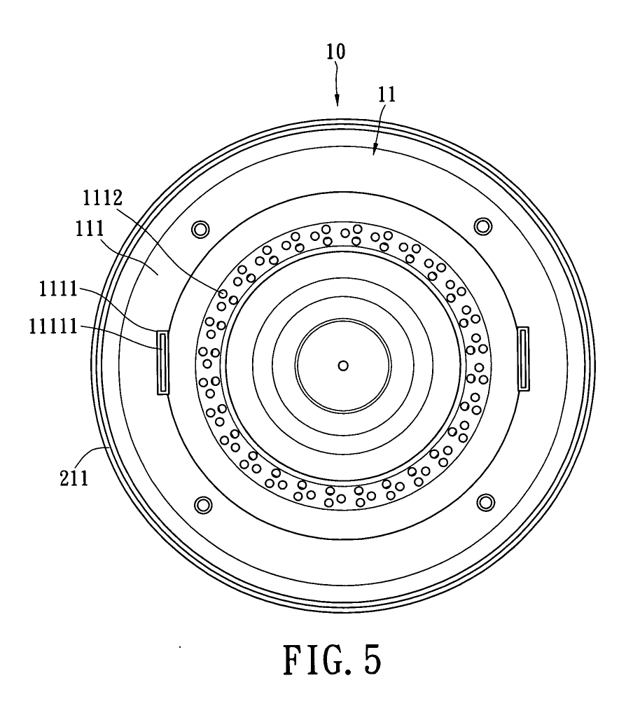

Please refer to FIG. 1 to FIG. 5. The present invention provides a speaker 1 with LEDs (Light Emitting Diode) and lampshell, comprising a shell 10, a lampshell 2, an illuminating device 3 and at least two buckle devices 4.

The speaker 1 has a shell 10 on its surrounding. A base 11 is arranged on the upper side of the shell 10. The base 11 has an upper surface 111 and a bottom surface 112. The upper surface 111 perpendicularly protrudes at least two connection portions 1111. In this embodiment, the number of the connection portions 1111 is two, and the number of the connection portions 1111 is used for example. The number of the connection portions 1111 in actual usage is not limited. The two connection portions 1111 combine with the upper surface 111 by one-piece. The two connection portions 1111 are plate-like. The two connection portions 1111 are located oppositely on the upper surface 111. The two connection portions 1111 are corresponding to each other. Besides, each connection portion 1111 is concave to form an embodied groove 11111. Between the upper surface 111 and the bottom surface 112 protrudes a plurality of dissipation holes 1112, letting the heat created during the period of the vibration and electrical connection of the speaker 1 be dissipated. The bottom surface 112 protrudes downward an engaging wall 1121. In this embodiment, the engaging wall 1121 is ring-like.

The lampshell 2 is located below the bottom surface 112 of the base 11. In this embodiment, the lampshell 2 is ring-like, but the shape of the lampshell 2 can also be triangle, square, or other shape. In this embodiment, the lampshell 2 made of plastic which is semitransparent. The lampshell 2 has an illuminating portion 21 and a surrounding wall 22. Referring to FIG. 1, the illuminating portion 21 is ring-like and has a curved surface. The upper side of the illuminating portion 21 protrudes inward a rib 211. The rib 211 buckles on the edge of the upper surface 111 of the base 11, letting the lampshell 2 combined with the speaker 1. The bottom of the illuminating portion 21 is connected with the surrounding wall 22. The surrounding wall 22 extends upward from the bottom of the illuminating portion 21 to the bottom of the bottom surface 112. The inner side of the surrounding wall 22 covers the outer side of the engaging wall 1121.

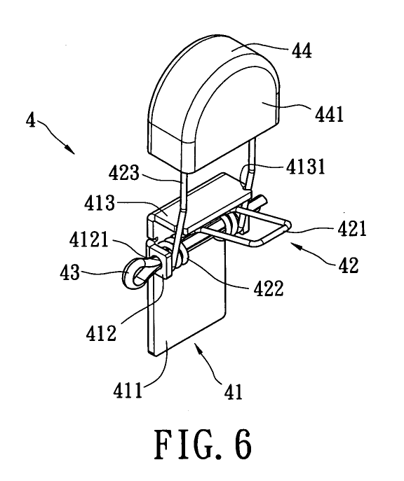

The illuminating device 3 is located between the lampshell 2 and the bottom surface 112 of base 11. In this embodiment, the illuminating device 3 is located among the bottom surface 112, illuminating portion 21, and surrounding wall 22. The illuminating device 3 has a LED board 31 and a plurality of LEDs 32. The shape of the LED board 31 is corresponding to that of the illuminating portion 21. The LEDs 32 electrically connect on the bottom of the LED board 31. When the current passes through the LEDs 32 and the LEDs 32 start to emit beams, the beams will go through the illuminating portion 21. The beams pass from the illuminating portion 21 will be tender and equally arranged. It would be not easy to recognize that the beams are emitted from the LEDs 32. The LEDs 32 are also save more electricity and have longer life compared with the conventional bulbs. Besides, the heat created in use can be dissipated by the contact between the LED board 31 and the bottom surface 112. The LED board 31 can be one piece with ring-like shape, but it can also be separate multiple pieces screwed on the bottom surface 112 of the base 11. Please refer to the FIG. 6 to FIG. 8, each of the buckle device 4 has a spring base 41, a spring clip 42, a shaft 43, and a pad 44. The buckle device 4 illustrated here is one example of this particular aspect of the overall invention

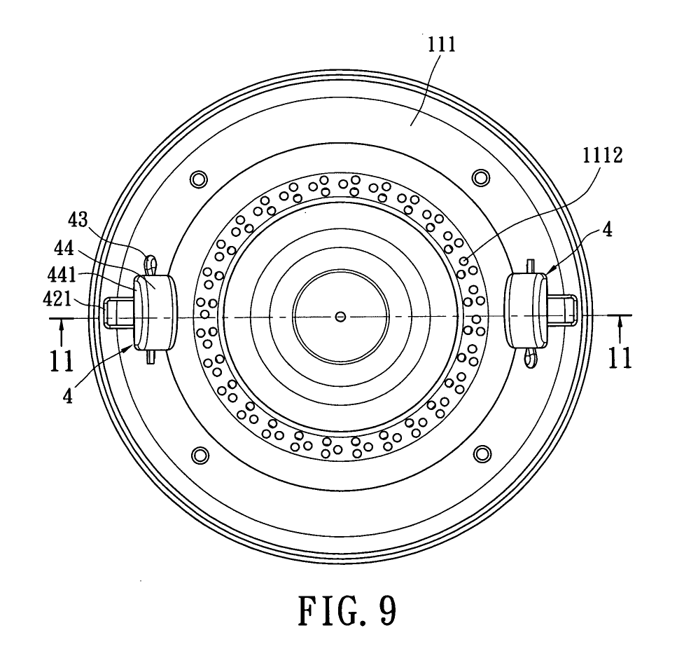

The spring base 41 has a base board 411, two accommodating portion 412, and an engaging board 413. The bottom shape of the base board 411 is corresponding to the embodied groove 11111. The bottom of the base board 411 is inserted into the embodied groove 11111 of the connection portion 1111. Referring FIG. 9 to FIG. 11, the user can smear glue on the bottom of the base board 411 to get fixed before the bottom of the base board 411 inserted into the embodied groove 11111. Or, after the bottom of the base board 411 inserted into the embodied groove 11111, the user can use screws screwing and penetrating through the connection portion 1111 and the base board 411, preventing the base board 411 from departing from the embodied groove 11111. Of course, except the above embodiment, the connection portion 1111 can be made without arranging the embodied groove 11111. The base board 411 and the connection portion 1111 can be fixed by smearing the glue between the base board 411 and the connection portion 1111, or by making the base board 411 attach to the connection portion 1111 and then using the screw to penetrate the connection portion 1111 and the base board 411. The combination relationship mentioned above is presented as an example. The base board 411 of the spring base 41 may contact other place of the shell 10.

Referring to FIG. 6 to FIG. 8, the two accommodating portions 412 extend perpendicularly from the base board 411 in the same direction. In the embodiment, the two accommodating portion 412 protrude from the edge of the sides of the base board 411. Each accommodating portion 412 has a through hole 4121.

The engaging board 413 perpendicularly extends from the base board 411 in one piece. In the embodiment, the engaging board 413 perpendicularly extends from the upper edge of the base board 411. The engaging board 413 is plate-like. The two corners of the engaging board 413, each of which indents an engaging groove 4131 toward the base board 411.

The spring clip 42 has a forced portion 421, two bent portions 422, and two supporting rods 423. The forced portion 421, the two bent portions 422, and the two supporting rods 423 are metallic material and were formed in one piece. The forced portion 421 is an “n” shaped rod. Of course, the shape of the forced portion 421 is presented for an example. Two ends of the forced portion 421 are connected with the ends Of the two bent portions 422, separately. The two bent portions 422 are shown in helix spring structure. The two bent portions 422 spin in different directions (clockwise and counter clockwise). The other ends of the two bent portions 422 extend the two supporting rods 423. The two supporting rods 423 are parallel to each other. There forms a certain angle between the forced portion 421 and the two supporting rods 423.

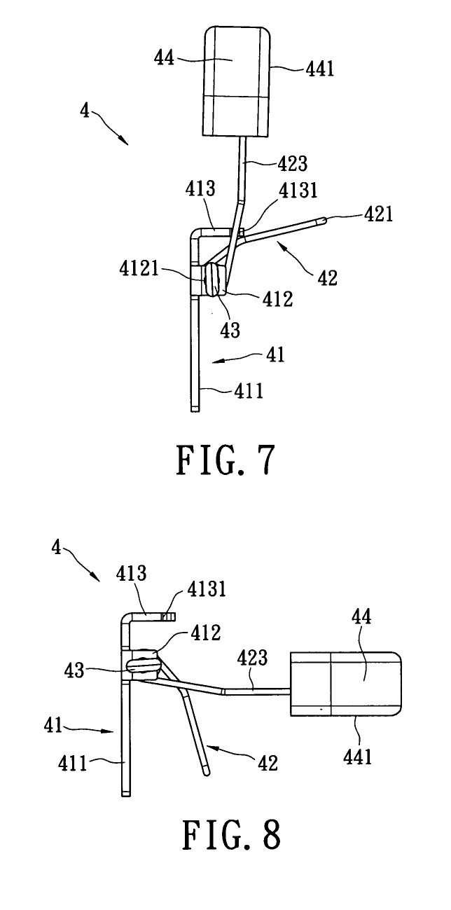

When the user assembles the buckle device 4, the two bent portions 422 of the spring clip 42 are located between the two accommodating portions 412. The two bent portions 422 are corresponding to the two through holes 4121. The shaft 43 passes through the two through holes 4121 and the two bent portions 422, letting the spring clip 42 rotate-ably connects with the spring base 41, as shown in FIG. 7 and FIG. 8. Besides, referring to FIG. 11, the bottom of the pad 44 is inserted by the two supporting rods 423 to fix. The material of pad 44 is rubber, allowing the inner side of the pad 44 offers a preferable friction, such that the pad 44 may not easily slide from the supporting rod 423. Referring to FIG. 6 again, before the spring clip 42 rotates, the two supporting rod 423 are engaged with the engaging grooves 4131 of the engaging board 413. When the connection portion 1111 of the shell 10 is higher and the length of the base board 411 is longer (to increase the connection strength between the base board and the shell 10), the length of the supporting rods 423 is changeable with the length of the engaging board 413. Therefore the two supporting rods 423 can still be engaged with the engaging grooves 4131 of the engaging board 413.

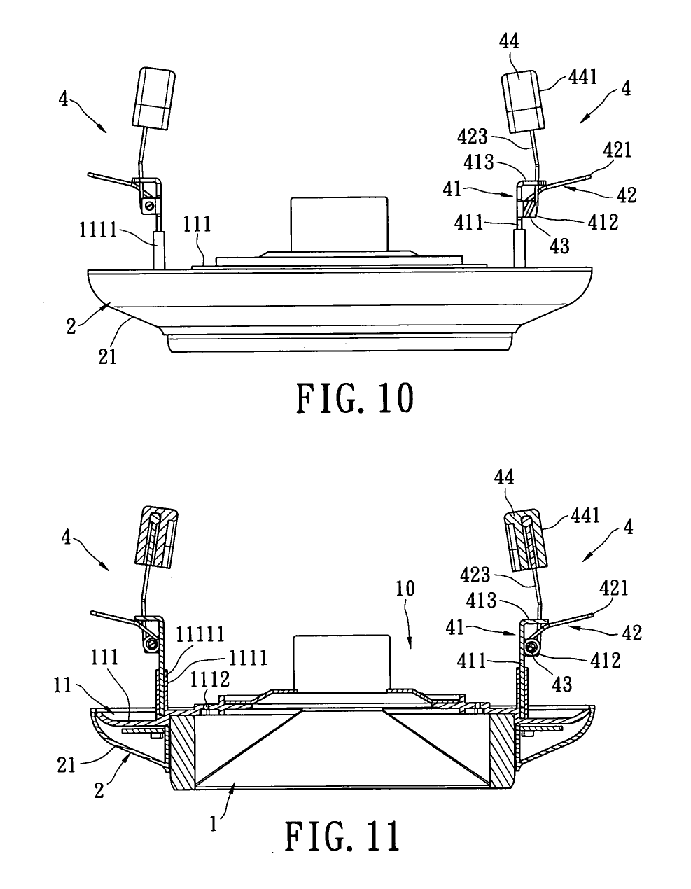

In the embodiment, the number of the buckle device 4 is two. After the buckle devices are assembled, the user can use the spring base 41 of the of the buckle device 4 to connect with the connection portion 1111, such that the buckle devices 4 are able to connect with the base 11. The two buckle devices 4 are in opposite position. Each the pad 44 of the buckle device 4 has a contact surface 441. The two contact surfaces 441 are arranged toward opposite direction, as shown in FIG. 10.

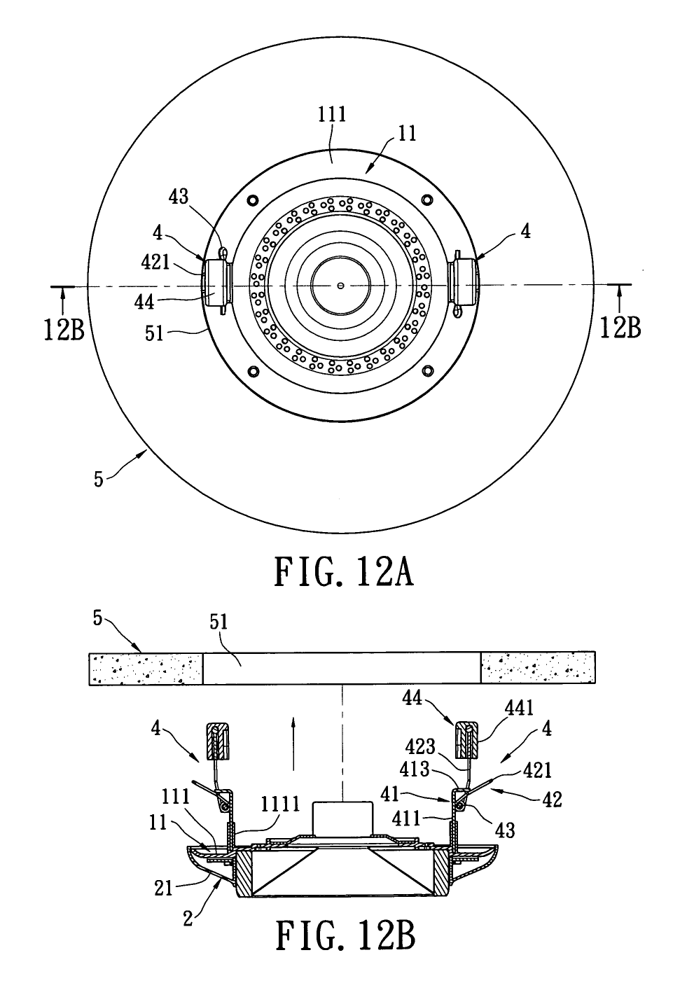

Referring to FIG. 12A and FIG. 12B, a ceiling 5 is located above the present invention. There is an opening 51 on the ceiling 5 corresponding to the two buckle devices 4. In the meantime, the two supporting rods 423 are engaged with the engaging grooves 4131. The user is going to push the present invention upward.

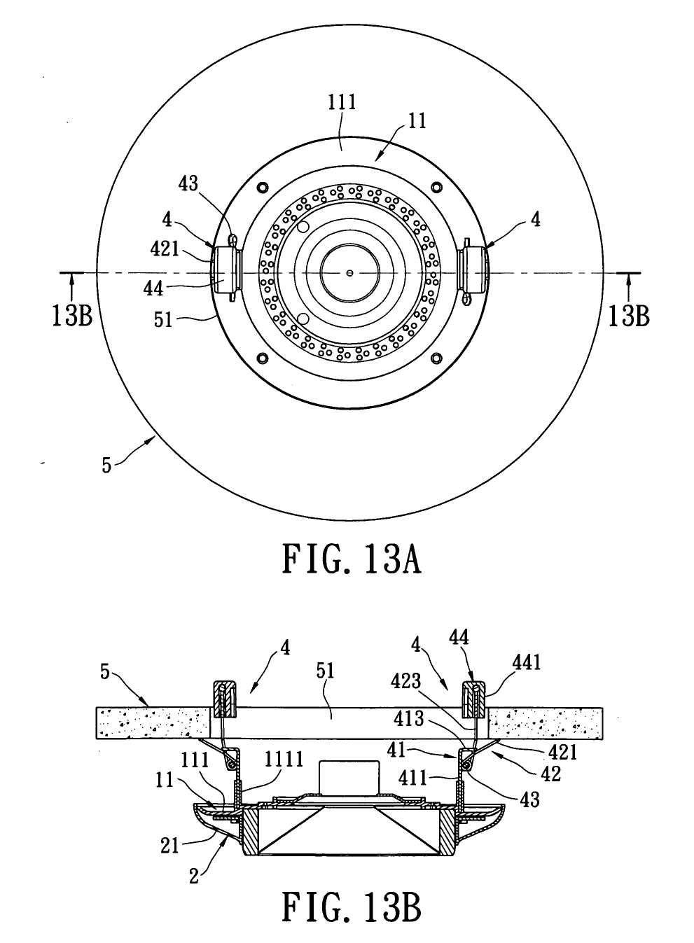

Referring to FIG. 13A and FIG. 13B, in the process of the user pushing the present invention toward the ceiling 5, the pads 44 and partial supporting rod 423 pass through the opening 51 of the ceiling 5. In the meantime, the largest distance between the two forced portions 421 is longer than the diameter of the opening 51. The upper surfaces of the forced portions 421 contact with the bottom surface of the edge of the opening 51 of the ceiling 5.

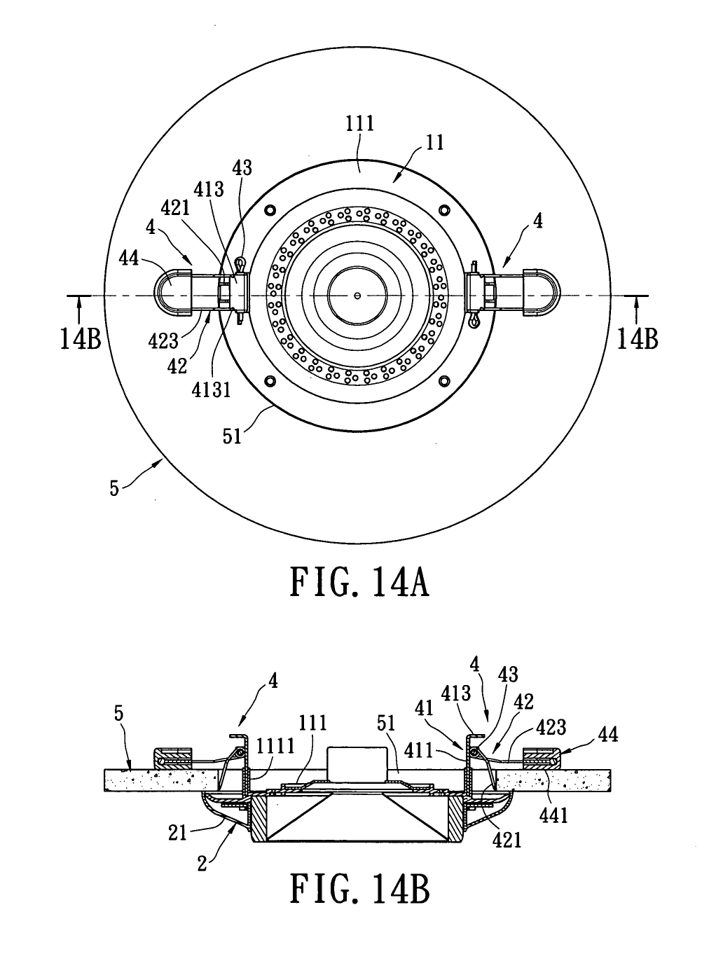

Referring to FIG. 14A and FIG. 14B; they show the status of the present invention after the user pushes the present invention toward the ceiling 5. By the relationship that the spring clip 42 is able to rotate relative to the spring base 41, the two supporting rods 423 leave from the engaging groove 4131. The two forced portions 421 are located between the upper and the bottom of the ceiling 5. The two forced portions 421 were pushed (counterforce) from the opening 51 of the ceiling 5, making the two supporting rods 423 rotate oppositely and press toward the upper edge of the opening 51 of the ceiling 5. The two contact surfaces 441 of the supporting rods 423 contact on the upper surface of the ceiling 5. Therefore, the two buckle device 4 can counter the weight of the present invention to stay on the ceiling 5.

Of course, in real use, it is practical to add the number of the buckle device 4 to increase the total buckle effect of loading. If there are three buckle devices 4 on the base 11, each two of buckle devices 4 is formed in 120 degrees. If there are four buckle devices 4 on the base 11, each two of buckle devices 4 is formed in 90 degrees. Besides, another way to increase the total buckle effect of loading is to replace the spring clip 42 with a thick one.

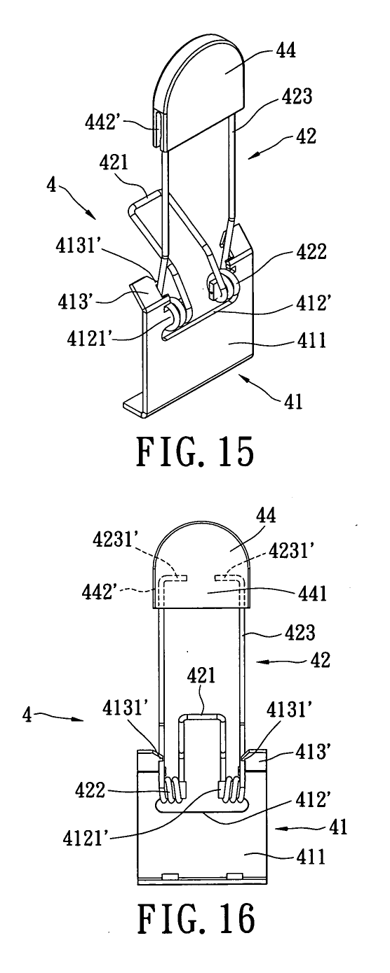

Referring to FIG. 15 and FIG. 16, it is another embodiment of the buckle device 4 of the present invention. The spring base 41 has a concave opening 412′ and two engaging pieces 413′. The middle of the upper side of the base board 411 arranges the concave opening 412′. The two sides of the concave opening 412′ extend two shaft portions 4121′. The upper portions of the two sides of the concave opening 412′ extend obliquely to form two engaging piece 413′. The two engaging pieces 413′ oppositely are arranged two thorns 4131′. The two bent portions 422 of the spring clip 42 were inserted by the two shaft portions 4121′, letting the spring clip 42 rotatable relative to the spring base 41. Before the spring clip 42 rotates, the two supporting rods 423 are engaged with the two thorns 4131′ of the engaging pieces 413′. When the present invention is pushed to the opening 51 of the ceiling 5, as previous situation, the two supporting rods 423 leave (depart) from the thorns 4131′ of the two engaging piece 413′. The two contact surfaces 441 contact on the upper surface of the ceiling 5.

Besides, two sides of the pad 44 are arranged two guiding grooves 442′. The end of each of the supporting rod 423 is bent to form a penetrating rod 4231. The two penetrating rod 4231 further penetrate into the two sides of the pad 44, such that the spring clip 42 can be combined with the pad 44.

To sum up, the present invention has several merits which include:

1. The structure of the buckle device 4 of the present invention is simple and available to combine with the shell 10. The effect of fixing on the ceiling is good.

2. The user only need to push the present invention to the opening 51 of the ceiling 5, and the present invention can fix on the ceiling 5 easily.

3. The present invention not only provides sound but also emits beam, such that it is helpful to illuminate. The user used to arrange a great number of openings 51 of the ceiling 5 to fix the speakers or lamps. The present invention provides sound and light effect that the user may have fewer openings 51 of the ceiling 5 arranged. It is easy to arrange the present invention and show a better look.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A speaker, comprising:
a shell, the upper side of the shell has a base;
a lampshell, located below the base, the lampshell combines with the speaker, and the lampshell has an illuminating portion; and
an illuminating device, located between the lampshell and the base, the illuminating device has a LED board and a plurality of LEDs, and the LEDs electrically connect on the bottom of the LED board.

2. The speaker as claimed in claim 1, wherein the present invention further includes at least two buckle devices, each of the buckle device has a spring base, a spring clip and the spring base connect to the shell.

3. The speaker as claimed in claim 2, wherein the base has an upper surface and a bottom surface, between the upper surface and the bottom surface protrudes a plurality of dissipation holes.

4. The speaker as claimed in claim 2, wherein the lampshell has a surrounding wall, and the surrounding wall extends upward from the bottom of the illuminating portion.

5. The speaker as claimed in claim 4, wherein the base has a bottom surface, the bottom surface protrudes downward an engaging wall, and the surrounding wall covers the outer side of the engaging wall.

6. The speaker as claimed in claim 2, wherein the illuminating portion is ring-like and has a curved surface.

7. The speaker as claimed in claim 2, wherein the base has an upper surface, the upper side of the illuminating portion protrudes inward a rib, and the rib buckles on the edge of the upper surface of the base.

8. The speaker as claimed in claim 2, wherein the spring base further includes a base board and an engaging board, a concave opening and two engaging pieces, the upper side of the base board has a concave opening, the two sides of the concave opening extend two shaft portions, the two engaging pieces arrange two thorns.

9. The speaker as claimed in claim 8, wherein the spring clip has a forced portion, two bent portions, and two supporting rods, two ends of the forced portion are connected with the ends of the two bent portions, the other ends of the two bent portions extend the two supporting rods, the two bent portions of the spring clip were inserted by the two shaft portions, the two supporting rods are engaged with the two thorns.

10. The speaker as claimed in claim 2, wherein the present invention further includes a shaft, and the spring base further includes a base board and an engaging board, the two corners of the engaging board, each of which indents an engaging groove.

11. The speaker as claimed in claim 10, wherein the spring clip has a forced portion, two bent portions, and two supporting rods, two ends of the forced portion are connected with the ends of the two bent portions, the other ends of the two bent portions extend the two supporting rods, the shaft passes through the spring base and the two bent portions, and the two supporting rods are engaged with the engaging grooves.
